(19) United States
(12) Patent Application Publication
(10) Pub. No.: US 2006/0006232 A1
(43) Pub. Date: Jan. 12, 2006

(54) Card reader

(76) Inventors: Chi-Tung Chang, Taipei County (TW); I-Chieh Lin, Taipei County (TW); Chao-Yu Chen, Taipei County (TW)

Correspondence Address: Chi-Tung Chang, 7F., No. 213, Civic Boulevard. Sec. 4, Taipei, 105, TW

(21) Appl. No.: 10/888,621

(22) Filed: Jul. 12, 2004

(51) Int. Cl. G06K 7/06

(52) U.S. Cl. 235/441

(57) ABSTRACT

A card reader includes at least one card slot for a memory card to insert therein, a USB plug allowing hot attach and detach to and from a computer, and an IDE slot provided at one side of the card reader for a hard disk having an IDE slot to connect thereto. Therefore, with the card reader, a general hard disk may be treated as a high-capacity memory card and connected to the card reader in the manner of hot attach and detach.

### FIELD OF THE INVENTION

The present invention relates to a card reader, and more particularly to a card reader that is able to treat a general hard disk as a high-capacity memory card, allowing the hard disk to be connected to the card reader in the manner of hot attach and detach.

### BACKGROUND OF THE INVENTION

Flash memory cards are high-capacity storing media developed to meet consumers' demands in storing the huge amount of information and data, and have been widely adopted by consumers to replace the conventional floppy disk. The flash memory cards also lead to the prosperous development in the card reader industry.

Several years ago, the flash memory cards were popular only in the field of digital camera, and most of them were directly connected to a computer via a USB data transmission line. The most important function of the flash memorv card at that time was to store photos taken with a digital camera. However, the flash memory card must be connected to the computer via a transmission line and a driver must be installed in the computer for the flash memory card to work. Inconveniences exist when the flash memory card is to be used on more than one computer. Nevertheless, flash memory cards can be applied in the computer field to store multi-media information and contribute to the development of card readers that are now an important apparatus bridging the flash memory cards and computers.

The main function of the card reader is obviously to serve as a bridge between the flash memory card and the computer to complete data transmission between them. With the card reader, a user may browse photos stored on the flash memory card, listening music, and storing files on a computer without the need of using a digital camera connected to the computer via a transmission line. The flash memory card is therefore effortlessly upgraded to a mini massive storage device that can be easily carried along with a user. Currently, there are various types of card readers for use with flash memory cards of different specifications, such as, for example, CompactFlash Type I&II (CF), Microdrive (MD), SmartMedia (SM), Memory Stick (MS), MS Pro, MS Duo, MultiMedia Card (MMC). Secure Digital (SD), and the newly developed xD Picture card (xD). With the introduction of the above-mentioned various types of flash memory cards into the market, the card readers also have been developed from the type of one reader one slot to the type of one reader multiple slots to adapt to different flash memory cards.

While the above various types of flash memory cards provide consumers with more conveniences in using a computer, it is doubtless the hard disk is still the most important peripheral apparatus of a computer for storing data. This is because the hard disk has the advantages of having a read/write access rate far faster than that of the flash card; and having a price per capacity unit cheaper than that of the flash card. Whenever a user purchases to a new computer, some parts in the old computer that are still usable are usually dismounted from the old computer and re-mounted in the new computer. The hard disk that has a large quantity of data stored thereon is usually the first item being considered for re-mounting in the new computer.

Currently, all the hard disks include an IDE (Integrated Drive Electronics) interface and are connected to the main board of the computer via a flat cable having an IDE connector. In dismounting and re-mounting such hard disk, it is necessary to open the cases of both the old and the new computer. Alternatively, the computer is provided with a hard disk slot having a double-sided IDE socket provided therein for the above-mentioned flat cable to connect thereto. In the latter case, it is necessary to purchase a removable cartridge for the hard disk, and the removable cartridge is internally provided with a double-sided IDE socket, to one side of which the hard disk is connected, and to the other side of which an inner side of the hard disk slot on the computer is connected. In this manner, the hard disk can be carried along with the user for use at different places.

To mount and dismount the above hard disk to and from the computer, the computer must be shut down first. This procedure is apparently incomparable to the currently prevailed hot attach and detach technique. Moreover, it would cause inconveniences when a lot of other peripherals are forced to power off during mounting or dismounting of the hard disk. On the other hand, while the conventional card readers allow the memory cards to plug and play, the memory cards have a memory capacity much smaller than that of the hard disk and fail to satisfy users in terms of the access and application of multi-media. The memory cards have a read/write access rate slower than that of the hard disk, and are more expensive than the hard disk. More specifically, it is desirable to add a hard disk interface in a flash card reader because, in this multimedia world, more and more content is digitalized and the digital files are getting huge, it is hard to delivery video via flash card due to its capacity and access rate. Besides, more and more people have a second hard disk because the personal computer has been largely upgraded.

Therefore, it would be desirable for a hard disk to plug and play via a card reader to compensate for the insufficient capacity of the memory card.

### SUMMARY OF THE INVENTION

A primary object of the present invention is to provide a card reader that is able to treat a general hard disk as a high-capacity memory card and allows the hard disk to have the feature of hot attach and detach via the card reader.

To achieve the above and other objects, the card reader according to the present invention includes at least one card slot for a memory card to insert therein, a USB plug allowing hot attach and detach to and from a computer, and an IDE slot provided at one side of the card reader for a hard disk having an IDE slot to connect thereto. Therefore, with the card reader, a general hard disk can be treated as a high-capacity memory card and connected to the card reader in the manner of hot attach and detach.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a perspective structural diagram of a card reader according to the present invention; and

FIG. 2 is a block diagram showing an internal structure of the card reader of the present invention.

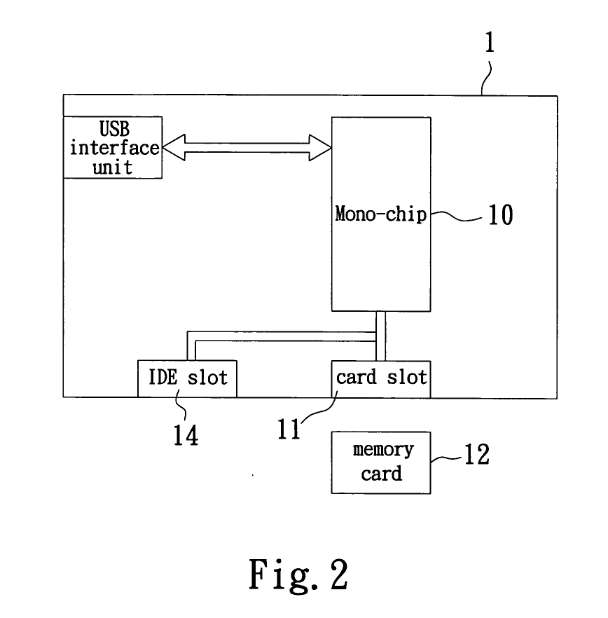

### DETAILED DESCRIPTION OF THE PREFERRED EMBODIMENTS

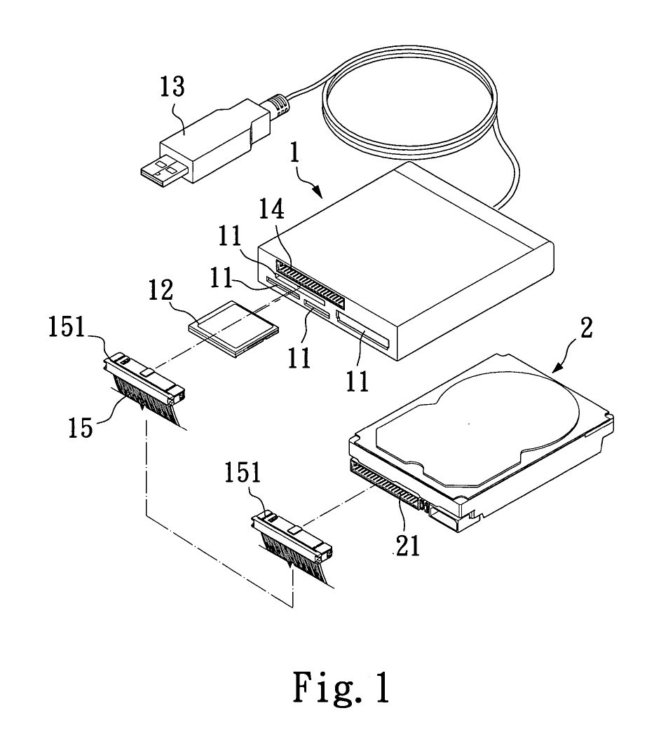

Please refer to FIG. 1 that is a perspective structural diagram of a card reader according to the present invention. As shown, the card reader, which is generally denoted by reference numeral 1, is provided with four card slots 11 for different types of flash memory cards 12 to insert thereinto. The flash memory cards 12 that may be connected to the card reader 1 include SD, mini-SD, MMC, RS-MMC, CF, MD, MS, MS-PRO, MS-DUO, SMC, and xD. The card reader 1 is also provided with a USB plug 13 that allows hot attachment and detachment of the card reader 1 to and from a computer. An IDE (Integrated Drive Electronics) slot 14 is provided on one side of the card reader 1. The IDE slot 14 of the card reader 1 may be electrically connected to an IDE slot 21 on a hard disk 2 via a flat cable 15 having IDE connectors 151 provided at two ends of the cable. It is noted the card reader 1 is not necessarily connected to the hard disk 2 via a flat cable. The IDE slot 14 may be otherwise provided at a rear end of the card reader 1, so that the hard disk 2 may be superposed on the card reader 1 with the IDE slot 21 of the hard disk 2 directly connected to the IDE slot 14.

The card reader 1 is internally provided with an IDE interface connected to a mono-chip 10 to use pins of the mono-chip 10 corresponding to a CF memory card, so that the IDE slot 14 allows an external apparatus to connect thereto in the manner of hot attach and detach. The mono-chip 10 is adapted to control the boot of the card reader 1 and treats the hard disk 2 as one type of memory card. When the card reader 1 is booted, the mono-chip 10 automatically detects the memory card slots 12 and the IDE slot 14 for any memory card inserted therein. When the hard disk 2 is detected, the mono-chip 10 would support the hard disk 2 with at least 200 ms of delayed power supply. When the hard disk 2 is unplugged, the mono-chip 10 would disconnect the hard disk 2 first to protect built-in data of the hard disk 2.

In this manner, the general hard disk 2 may be treated as a high-capacity memory card to achieve the function of hot attach and detach of the hard disk.

The present invention has been described with a preferred embodiment thereof and it is understood that many changes and modifications in the described embodiment can be carried out without departing from the scope and the spirit of the invention that is intended to be limited only by the appended claims.

What is claimed is:

1. A card reader, comprising at least one card slot for a memory card to insert thereinto, a USB plug that allows hot attach and detach of said card reader to and from a computer, and an IDE slot provided on one side of said card reader for a hard disk having an IDE slot to connect thereto.

2. The card reader as claimed in claim 1, wherein total four said card slots are provided at one side of said card reader, and wherein said memory cards for inserting in said card slots are flash memory cards of different specifications, including SD, mini-SD, MMC, RS-MMC, CF, MD, MS, MS-PRO, MS-DUO, SMC, and xD.

3. The card reader as claimed in claim 1, wherein said hard disk is connected to said card reader via a flat cable having an IDE connector provided at each end of said cable.

4. The card reader as claimed in claim 1, wherein said hard disk is connected to said card reader by directly connecting said IDE slot on said hard disk to said IDE slot on said card reader.
